(19) United States
(12) Patent Application Publication
(10) Pub. No.: US 2025/0344164 A1
(43) Pub. Date: Nov. 6, 2025

(54) RADIO FREQUENCY EXPOSURE COMPLIANCE USING SUBBAND TRANSMISSION POWER LIMITS

(71) Applicant: QUALCOMM Incorporated, San Diego, CA (US)

(72) Inventors: Akhil DEODHAR, Louisville, CO (US); Troy CURTISS, Boulder, CO (US); Scott HOOVER, Del Mar, CA (US); Jagadish NADAKUDUTI, Bermuda Dunes, CA (US); Lin LU, San Diego, CA (US)

(21) Appl. No.: 19/199,017

(22) Filed: May 5, 2025

Related U.S. Application Data
(60) Provisional application No. 63/643,277, filed on May 6, 2024.

(51) Int. Cl. H04W 52/42; H04W 52/22; H04W 52/36

(52) U.S. Cl. CPC H04W 52/42; H04W 52/225; H04W 52/367

(57) ABSTRACT

Techniques and apparatus for radio frequency (RF) exposure compliance based on subband transmit power limits are described. An example method that may be performed by a wireless device includes determining a transmit frequency band of at least one radio of the wireless device for transmission of a signal having an operating transmit frequency in the transmit frequency band. A transmit power limit associated with a subband in the transmit frequency band is determined based at least in part on the transmit frequency band. The operating transmit frequency of the signal is in the subband. The signal is transmitted using the at least one radio at a transmit power determined based at least in part on the transmit power limit in compliance with an RF exposure limit.

### CROSS-REFERENCE TO RELATED APPLICATION

This application claims the benefit of U.S. Provisional Patent Application Ser. No. 63/643,277, filed May 6, 2024, which is hereby incorporated by reference herein in its entirety for all applicable purposes.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices currently undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance while complying with radio frequency (RF) exposure limits.

Certain aspects of the subject matter described in this disclosure can be implemented in a method for wireless communication. The method generally includes determining a first transmit frequency band of at least one radio of a wireless device for transmission of a first signal having an operating transmit frequency in the first transmit frequency band. The method also includes determining, based at least in part on the first transmit frequency band, a first transmit power limit associated with a subband in the first transmit frequency band, the operating transmit frequency of the first signal being in the subband. The method further includes transmitting the first signal using the at least one radio at a first transmit power determined based at least in part on the first transmit power limit in compliance with a radio frequency (RF) exposure limit.

Certain aspects of the subject matter described in this disclosure can be implemented in an apparatus for wireless communication. The apparatus includes one or more memories collectively storing computer-executable instructions, and one or more processors coupled to the one or more memories. The one or more processors are collectively configured to execute the computer-executable instructions to cause the apparatus to: determine a transmit frequency band of at least one radio of the apparatus for transmission of a signal having an operating transmit frequency in the transmit frequency band; determine, based at least in part on the transmit frequency band, a transmit power limit associated with a subband in the transmit frequency band, the operating transmit frequency of the signal being in the subband; and transmit the signal using the at least one radio at a transmit power determined based at least in part on the transmit power limit in compliance with a radio frequency (RF) exposure limit.

Certain aspects of the subject matter described in this disclosure can be implemented in an apparatus for wireless communication. The apparatus includes means for determining a transmit frequency band of at least one radio of the apparatus for transmission of a signal having an operating transmit frequency in the transmit frequency band. The apparatus also includes means for determining, based at least in part on the transmit frequency band, a transmit power limit associated with a subband in the transmit frequency band, the operating transmit frequency of the signal being in the subband. The apparatus further includes means for transmitting the signal using the at least one radio at a transmit power determined based at least in part on the transmit power limit in compliance with a radio frequency (RF) exposure limit.

Certain aspects of the subject matter described in this disclosure can be implemented in a computer-readable medium. The computer-readable medium has instructions stored thereon, which when executed by one or more processors, cause the one or more processors to perform an operation. The operation generally includes determining a transmit frequency band of at least one radio of a wireless device for transmission of a signal having an operating transmit frequency in the transmit frequency band. The operation also includes determining, based at least in part on the transmit frequency band, a transmit power limit associated with a subband in the transmit frequency band, the operating transmit frequency of the signal being in the subband. The operation further includes transmitting the signal using the at least one radio at a transmit power determined based at least in part on the transmit power limit in compliance with a radio frequency (RF) exposure limit.

Certain aspects of the subject matter described in this disclosure can be implemented in a method for wireless communication. The method generally includes determining one or more transmit frequency bands supported by at least one radio of a wireless device. The method also includes, for at least one transmit frequency band of the one or more transmit frequency bands, determining a respective transmit power limit for at least one subband within the transmit frequency band for one or more transmit scenarios supported by the wireless device, such that a respective radio frequency (RF) exposure level for the at least one radio used in a transmission is in compliance with an RF exposure limit. The method further includes storing indications of the transmit power limits in a memory device.

Certain aspects of the subject matter described in this disclosure can be implemented in an apparatus for wireless communication. The apparatus includes one or more memories collectively storing computer-executable instructions, and one or more processors coupled to the one or more memories. The one or more processors are collectively configured to execute the computer-executable instructions to cause the apparatus to: determine one or more transmit frequency bands supported by at least one radio of a wireless device; for at least one transmit frequency band of the one or more transmit frequency bands, determine a respective transmit power limit for at least one subband within the transmit frequency band for one or more transmit scenarios supported by the wireless device, such that a respective radio frequency (RF) exposure level for the at least one radio used in a transmission is in compliance with an RF exposure limit; and store indications of the transmit power limits in a memory device.

Certain aspects of the subject matter described in this disclosure can be implemented in an apparatus for wireless communication. The apparatus includes means for determining one or more transmit frequency bands supported by at least one radio of a wireless device. The apparatus also includes, for at least one transmit frequency band of the one or more transmit frequency bands, means for determining a respective transmit power limit for at least one subband within the transmit frequency band for one or more transmit scenarios supported by the wireless device, such that a respective radio frequency (RF) exposure level for the at least one radio used in a transmission is in compliance with an RF exposure limit. The method further includes means for storing indications of the transmit power limits in a memory device.

Certain aspects of the subject matter described in this disclosure can be implemented in a computer-readable medium. The computer-readable medium has instructions stored thereon, which when executed by one or more processors, cause the one or more processors to perform an operation. The operation generally includes determining one or more transmit frequency bands supported by at least one radio of a wireless device. The operation also includes, for at least one transmit frequency band of the one or more transmit frequency bands, determining a respective transmit power limit for at least one subband within the transmit frequency band for one or more transmit scenarios supported by the wireless device, such that a respective radio frequency (RF) exposure level for the at least one radio used in a transmission is in compliance with an RF exposure limit. The operation further includes storing indications of the transmit power limits in a memory device.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with an RF exposure limit, in accordance with certain aspects of the present disclosure.

FIG. 4 is a diagram illustrating an example system for measuring RF exposure values, in accordance with certain aspects of the present disclosure.

FIG. 5 is a diagram illustrating an example frequency band, in accordance with certain aspects of the present disclosure.

FIG. 6 is a diagram illustrating an example frequency band with one or more subbands, in accordance with certain aspects of the present disclosure.

FIG. 7 depicts an example data structure, in accordance with certain aspects of the present disclosure.

FIG. 8 is a flow diagram illustrating example operations for managing a time-averaged RF exposure evaluation, in accordance with certain aspects of the present disclosure.

FIG. 9 is a flow diagram illustrating example operations for wireless communication, in accordance with certain aspects of the present disclosure.

FIG. 10 is another flow diagram illustrating example operations for wireless communication by a wireless device, in accordance with certain aspects of the present disclosure.

FIG. 11 illustrates a communications device (e.g., a user equipment (UE)) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for radio frequency (RF) exposure compliance based at least in part on one or more subband (or sub-frequency band) transmission power limits.

In certain cases, a regulatory agency (e.g., the Federal Communications Commission (FCC) for the United States or the Innovation, Science and Economic Development Canada (ISED) for Canada) and/or a standards organization (e.g., the International Commission on Non-Ionizing Radiation Protection (ICNIRP)) may specify a time-averaged RF exposure limit in order to ensure safe levels of RF exposure as further described herein. In such cases, a wireless device may evaluate RF exposure compliance using a time-averaged operation. For example, the wireless device may perform an RF exposure assessment of past RF exposure over a given time window (e.g., time-averaging time window) to determine a transmit power (e.g., maximum allowable transmit power) for a future time interval in the time window that is in compliance with the RF exposure limit (e.g., time-averaged RF exposure limit) for a given transmit scenario associated with the wireless device. As discussed further below, a transmit scenario may correspond to various combinations of radios, communication technologies (e.g., radio access technologies (RATs)), antennas, antenna groupings, antenna configurations (or beams) (e.g., transmit beam configuration), single-input, single-output (SISO) or multiple-input, multiple-output (MIMO) transmissions, operating conditions, frequency bands, channels, RF exposure scenarios (e.g., head exposure, body-worn exposure, extremity (hand) exposure, and/or hotspot exposure), device use-case scenarios (e.g., based on active applications on the device, such as voice vs. data applications, gaming vs. video-call applications active on the device), physical configurations of a device (e.g., folded, closed, unfolded, open), and/or geographical locations or regions (e.g., countries or regions), as illustrative, non-limiting examples.

In certain cases, RF exposure compliance testing may be performed for one or more transmit scenarios supported by the wireless device. The RF exposure compliance testing may involve determining RF exposure and corresponding transmit power limits (e.g., maximum allowable transmit powers) for each respective transmit scenario supported by the wireless device. The transmit power limits for each transmit scenario may be stored and accessed by the wireless device when performing a time-averaging operation.

Although RF exposure generally varies as a function of operating (e.g., transmit) frequency, under current RF exposure compliance certification processes, RF exposure is generally determined for the low channel, middle channel, and high channel for each transmit scenario supported by the wireless device, as opposed to every channel for each transmit scenario. For example, for a given frequency band supported by the wireless device, RF exposure may be determined for the lowest channel of the frequency band, the middle channel of the frequency band, and the highest channel of the frequency band, for each transmit scenario supported by the wireless device. Note, as used herein, a frequency band that is supported by a wireless device may refer to a frequency band that is specified or otherwise defined by an industry group (e.g., the 3^{rd} Generation Partnership Project (3GPP), Institute of Electrical and Electronics Engineers (IEEE), etc.), a regulatory agency (or body) (e.g., FCC, ISED, etc.), a standards organization (e.g., ICNIRP), or any combination thereof.

Consequently, under current RF exposure compliance certification processes, RF exposure compliance testing may determine a single transmit power limit (e.g., maximum allowable transmit power) for each respective frequency band supported by the wireless device, e.g., by taking the minimum transmit power limit out of the transmit power limits determined for the low, middle, and high channels of the frequency band. That is, as described in further detail below, the single transmit power limit for a given frequency band may be determined using the worst-case RF exposure (e.g., highest RF exposure) from the low channel, middle channel, and high channel of that frequency band.

In some cases, however, certain frequency bands may have a variation in RF exposure (and hence, the transmit power level) between the lowest frequency and the highest frequency of the band. Such a variation in RF exposure may be present in frequency bands that have a wide bandwidth (relative to the center frequency) (e.g., 900 megahertz (MHz) bandwidth for Frequency Range 1 (FR1) n77 band, 1.2 gigahertz (GHz) bandwidth for wireless local area network (WLAN) 6 GHz band, and other bands) as well as frequency bands that have narrower bandwidths (relative to the center frequency) (e.g., 60 MHz bandwidth for narrowband internet-of-things (NB-IoT) B1 band, 25 MHz for NB-IoT B5 band, 10 MHz for NB-IoT B13 band, and other bands). Accordingly, one potential drawback to determining and applying a single (e.g., minimum) transmit power limit for such frequency bands that have a variation in RF exposure between the lowest and highest frequencies is that the single transmit power limit can lead to sub-optimal performance for the wireless device in terms of reduced throughput, increased latency, and/or decreased transmission range, as illustrative, non-limiting examples.

Additionally, determining and applying a single transmit power limit for the entire frequency band can impact design criteria (or specifications) for antennas and/or RF circuitry of a wireless device, notwithstanding the amount of RF exposure variation in the frequency band and/or whether the frequency band has a large bandwidth relative to the center frequency. For example, there may be increased design complexity, cost, and/or development time for antennas and/or RF circuitry in order to ensure that applying the single transmit power limit for the entire frequency band will achieve a desired response across the entire frequency band.

Aspects of the present disclosure provide apparatus and methods for RF exposure compliance based at least in part on one or more subband (or sub-frequency bands) transmission power limits. For example, a respective transmit power limit may be determined for one or more subbands of a frequency band for each transmit scenario. As used herein, a subband of a frequency band may refer to any subset of frequencies within a frequency band as defined herein. The transmit power limit for a given subband may then be applied as part of a time-averaging operation. For example, the wireless device may implement a time-averaging operation that involves monitoring the operating transmit frequency and channel bandwidth to determine the applicable subband transmit power limit (e.g., based on transmit scenario) to use as the maximum time-averaged transmit power limit.

The apparatus and methods for RF exposure compliance based at least in part on one or more subbands described herein may provide various advantages. For example, in frequency bands that have a variation in RF exposure between frequencies within the band (e.g., wide frequency bands, narrow frequency bands, cellular frequency bands, wireless local area network frequency bands, etc.), the determination of transmit power limits on a subband level may provide a higher level of granularity that leads to a more optimal transmit power level for the time-averaging operation at a given operating transmit frequency of the wireless device. For example, the time-averaging operation can avoid using the worst-case RF exposure for the entire frequency band. As such, determining and applying transmit power limit(s) on a subband level may lead to improved performance for the wireless device in terms of increased throughput, decreased latency, and/or increased transmission range, as illustrative, non-limiting examples. Additionally, for certain frequency bands (e.g., narrower frequency bands), the determination of transmit power limits on a subband level may case design criteria (or specifications) for antennas and/or RF circuitry of a wireless device. For example, instead of ensuring a good response across an entire frequency band, transmissions can be adjusted appropriately for each of the subbands based on the respective subband transmit power limits. Consequently, there may be reduced design complexity, cost, and/or development time for antennas and/or RF circuitry when determining transmit power limits on a subband level.

The following description provides examples of RF exposure compliance, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a channel, a tone, a subband, etc. Each frequency may support a single RAT in a given geographic area in order to avoid interference between wireless networks of different RATs, or may support multiple RATs.

Although the terms “first,” “second,” “third,” etc., may be used herein to describe various devices, elements, components, regions, layers and/or sections, these devices, elements, components, regions, layers and/or sections should not be limited by these terms. These terms may be only used to distinguish one device, element, component, region, layer or section from another device, element, component, region, layer, or section. Terms such as “first,” “second,” and other numerical terms, when used herein, do not imply a sequence or order unless clearly indicated by the context. Thus, a first device, element, component, region, layer, or section discussed herein could be termed a second device, element, component, region, layer, or section without departing from the scope of the present disclosure.

As used herein, a radio may refer to a physical or logical transmission path associated with one or more frequency bands (carriers, channels, bandwidths, subdivisions thereof, etc.), transmitters (or transceivers), and/or RATs (e.g., radio frequency identification (RFID), wireless wide area network (WWAN) (including Fifth Generation (5G) New Radio (NR), Evolved Universal Terrestrial Radio Access (E-UTRA) (also known as a Fourth Generation (4G) RAT), Universal Mobile Telecommunications System (UMTS) (also known as a Second Generation (2G)/Third Generation (3G) RAT), and/or code division multiple access (CDMA) (also known as a 2G/3G RAT), WLAN RATs (e.g., Institute of Electrical and Electronics Engineers (IEEE) 802.11 (also known as WiFi)), short-range communications (e.g., Bluetooth), non-terrestrial communications, device-to-device (D2D) communications, vehicle-to-everything (V2X) communications, etc.) used for wireless communications. For example, for uplink carrier aggregation (or multi-connectivity) in WWAN, each of the active component carriers used for wireless communications may be treated as a separate radio. Similarly, multi-band transmissions for IEEE 802.11 may be treated as separate radios for each frequency band (e.g., 2.4 gigahertz (GHz), 5 GHZ, and/or 6 GHZ). In some examples, a radio is defined based on a RAT and/or frequency for the purposes of RF exposure determination and/or RF exposure compliance.

The techniques described herein may be used for various wireless networks and radio technologies. While aspects may be described herein using terminology commonly associated with 3G, 4G, and/or 5G (e.g., 5G NR) wireless technologies, aspects of the present disclosure can be applied in other generation-based communication systems and/or to wireless technologies such as IEEE 802.11, 802.15, etc.

The electromagnetic spectrum is often subdivided, based on frequency/wavelength, into various classes, bands, channels, etc. In 5G NR two initial operating bands have been identified as frequency range designations FR1 (410 megahertz (MHz)-7.125 gigahertz (GHz)) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band. Certain standards may further sub-divide operating bands FR1 and/or FR2 into one or more frequency bands, including, for example, n1 band to n109 band for FR1 and n257 to n263 for FR2. As used herein, each of the n1 to n109 bands for FR1 and each of the n257 to n263 bands within FR2 may be considered as a “frequency band” that is defined or specified by a regulatory body, standards organization, industry group, or combination thereof.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

### Example Wireless Communication Network and Devices

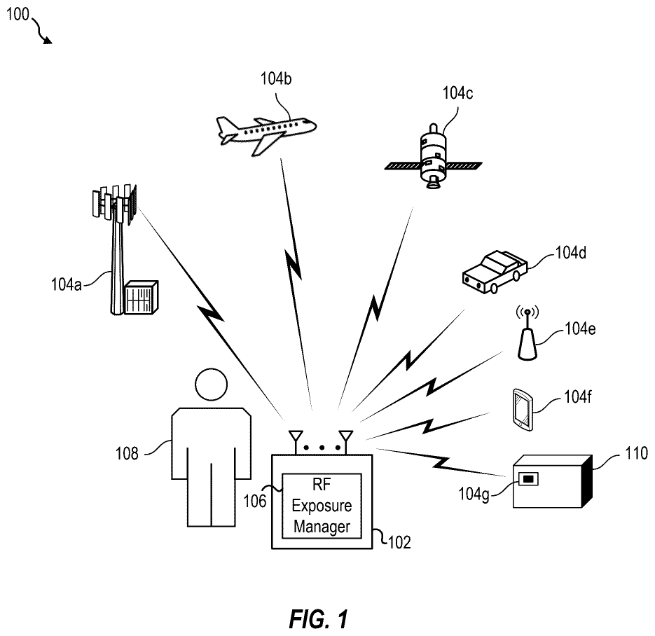

FIG. 1 illustrates an example wireless communication system 100 in which aspects of the present disclosure may be performed. For example, the wireless communication system 100 may include a WWAN, an RFID system, a D2D communications network, a V2X system, a WLAN, a short-range communications system (e.g., Bluetooth communications), or any combination thereof. For example, a WWAN may include an NR system (e.g., a 5G NR network), an E-UTRA system (e.g., a 4G network), a UMTS (e.g., a 2G/3G network), a CDMA system (e.g., a 2G/3G network), any future WWAN system, or any combination thereof. A WLAN may include a wireless network configured for communications according to an IEEE standard such as one or more of the IEEE 802.11 standards, etc.

As illustrated in FIG. 1, the wireless communication system 100 may include a wireless device 102 communicating with any of various wireless devices 104a-104g (a wireless device 104) via any of various radio access technologies (RATs), where a wireless device may refer to a wireless communication device. The RATs may include, for example, RFID communications, WWAN communications (e.g., E-UTRA and/or 5G NR), WLAN communications (e.g., IEEE 802.11), V2X communications, non-terrestrial network (NTN) communications, short-range communications (e.g., Bluetooth), etc.

The wireless device 102 may be emitting RF signals in proximity to a human 108, who may be the user of the wireless device 102 and/or a bystander. As an example, the wireless device 102 may be held in the hand of the human 108 and/or positioned against or near the head of the human 108. In certain cases, the wireless device 102 may be positioned in a pocket or bag of the human 108. In some cases, the wireless device 102 may positioned proximate to the human 108 as a mobile hotspot. To ensure the human 108 is not overexposed to RF emissions from the wireless device 102, the wireless device 102 may control the transmit power associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The wireless device 102 may include any of various wireless communication devices including a user equipment (UE), a wireless station, an access point, a customer-premises equipment (CPE), etc. In certain aspects, the wireless device 102 includes an RF exposure manager 106 that manages the RF exposure associated with one or more radios in compliance with an RF exposure limit, in accordance with aspects of the present disclosure. The RF exposure manager 106 may determine and apply transmit power limits based on one or more subbands for each transmit scenario, in accordance with aspects of the present disclosure.

The wireless devices 104a-104g may include, for example, a base station 104a, an aircraft 104b, a satellite 104c, a vehicle 104d, an access point 104c, a UE 104f, and/or a tag 104g. Further, the wireless communication system 100 may include terrestrial aspects, such as ground-based network entities (e.g., the base station 104a and/or access point 104c), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (cNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The tag 104g is generally representative of an RFID tag, which may include a small chip (e.g., integrated circuit (IC)) and an antenna that uses radio waves to transmit data. The tag 104g may be attached to, embedded in, or otherwise in close proximity with an object 110. The tag 104g may communicate with an RFID reader, such as a phone RFID reader (e.g., the wireless device 102 and/or UE 104f), via RFID communications. The tag 104g may be representative of various types of RFID tags, including passive RFID tags (e.g., tags that do not have their own power source and rely on the reader for energy), active RFID tags (e.g., tags that have their own power source), and semi-passive RFID tags (e.g., tags that have their own power source but rely on the reader's signal to communicate similarly to passive RFID tags), as illustrative examples.

The wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. A UE may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as RFID, 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., RFID, 3G, 4G, 5G, 802.11a/b/g/n/ac, etc.) and a second wireless communication technology operating above 6 GHZ (e.g., mm Wave 5G in 24 to 60 GHz bands, IEEE 802.11 ad or 802.11ay). In certain aspects, the wireless device may transmit signals using the first wireless communication technology (e.g., RFID, 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

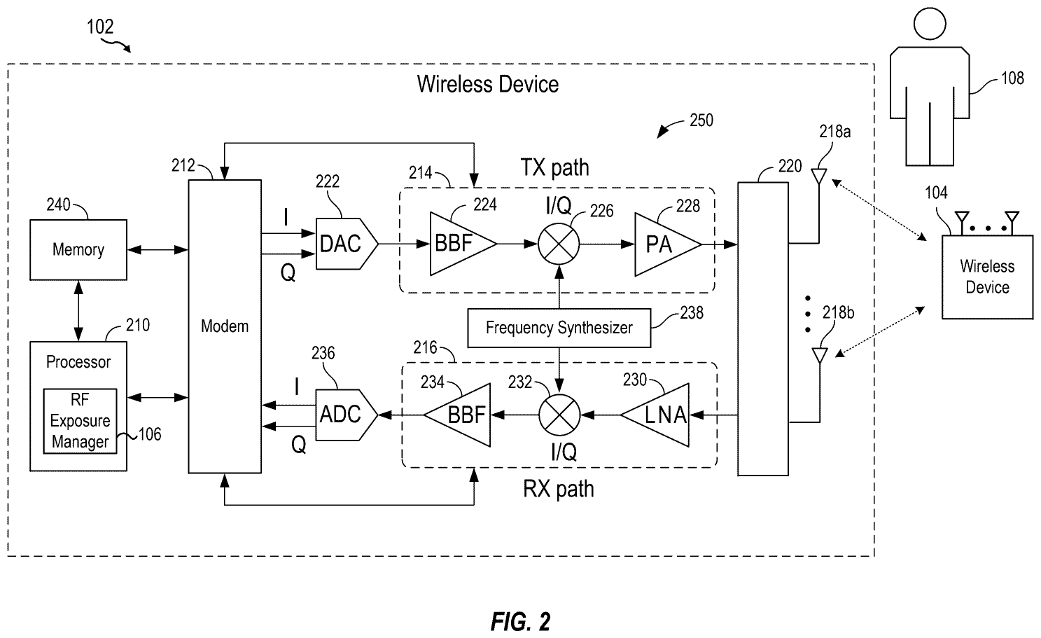

FIG. 2 illustrates example components of the wireless device 102, which may be used to communicate with any of the wireless devices 104, in some cases, in proximity to human tissue as represented by the human 108.

The wireless device 102 may be, or may include, a chip, system on chip (SoC), chipset, package or device that includes one or more modems 212. In some cases, the modem(s) 212 may include, for example, any of an RFID modem (e.g., a modem configured to communicate via RFID), a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the wireless device 102 also includes one or more radios (collectively “the radio(s) 250”). In some aspects, the wireless device 102 further includes one or more processors, processing blocks, or processing elements (collectively “the processor 210”) and one or more memory blocks or elements (collectively “the memory 240”).

The processor 210 may implement the RF exposure manager 106. In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem, the RFID modem, and/or Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC), a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the wireless device 102 may communicate via multiple-input, multiple-output (MIMO) signals. The wireless device 102 may transmit more than one signal via multiple antennas 218a, 218b (collectively “the antennas 218”) to the wireless device 104 through multipath propagation. As an example, a first signal may be transmitted via the first antenna 218a, and a second signal may be transmitted via the second antenna 218b via a different propagation path than the first signal. The MIMO signals may facilitate increased communication link capacity (e.g., throughput) between the wireless device 102 and the wireless device 104.

The RX path 216 may include a low noise amplifier (LNA) 230, a mixer 232, and a baseband filter (BBF) 234. RF signals received via the antenna 218 (e.g., from the wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to TX path 214 including the BBF 224, the mixer 226, and/or the PA 228) that complies with an RF exposure limit set by country-specific regulations and/or international guidelines (e.g., ICNIRP guidelines) as described herein.

FIG. 2 shows one reference example of a transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example RF Exposure Compliance

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

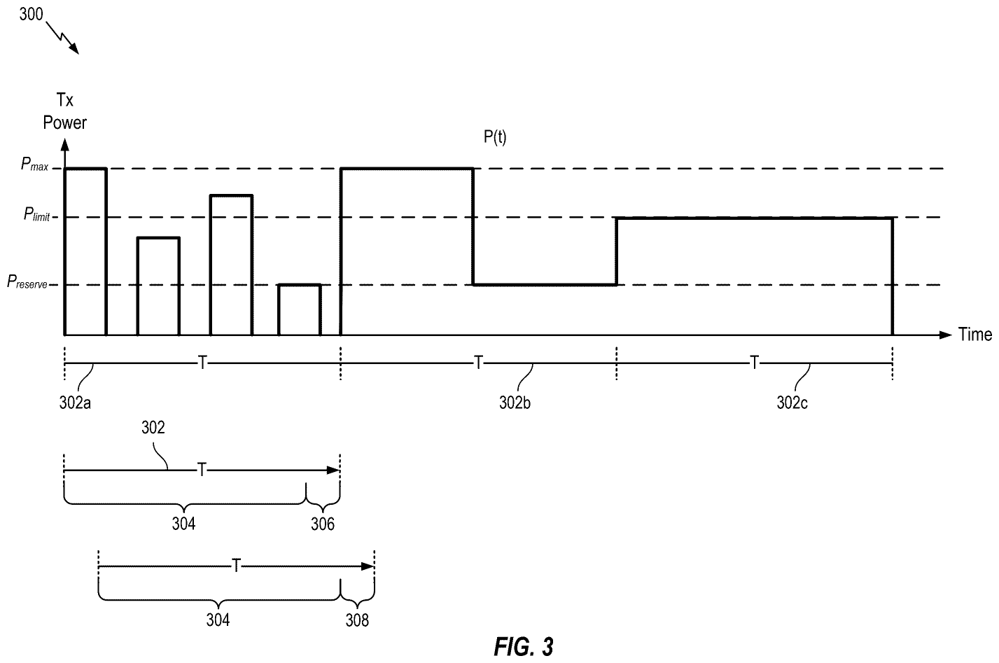

FIG. 3 is a graph 300 of a transmit power over time (P(t)) that varies over a running (e.g., rolling or moving) time window (T) associated with the RF exposure limit. The wireless device (e.g., the wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, such as in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the time window 302c such that the time-averaged transmit power over the time window (e.g., the time window 302c) is equal to Pₗᵢₘᵢₜ in compliance with the time-averaged RF exposure limit. The RF exposure level corresponding to time-averaged transmit power limit (Pₗᵢₘᵢₜ) may be referred to as an RF exposure design target. The RF exposure design target may be less than or equal to the RF exposure limit. The RF exposure design target may be selected to be less than the RF exposure limit to account for device uncertainty and/or to meet the RF exposure limit in exposure scenarios when transmitting simultaneously with other radios within the same device that have a different RF exposure controlling mechanism.

In certain cases, an instantaneous transmit power may exceed Pₗᵢₘᵢₜ in certain transmission occasions, for example, as shown in the time window 302a and the time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, PCMAX). In some cases, the wireless device may transmit at a transmit power less than or equal to Pₗᵢₘᵢₜ in certain transmission occasions, for example, as shown in the time window 302a.

In certain cases, a reserve power may be used to enable a continuous transmission within a time window (T) when transmitting above Pₗᵢₘᵢₜ in the time window or to enable a certain level of quality for certain transmissions. As shown in the time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P(t)) in the time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-averaged mode illustrated in the time window 302b. While a single transmit burst is illustrated in the time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the time window 302a, the duty cycle may be greater than 50% of the duration of the time window (T), whereas in the time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

### Example RF Exposure Measurements

In certain cases, the RF exposure of a wireless device may be certified with a regulatory agency (e.g., the FCC for the United States or the Innovation, Science and Economic Development Canada (ISED) for Canada). Spatial measurements may be taken with respect to a model (phantom) representing the human body, where the model may be filled with a liquid simulating human tissue. As discussed above, the wireless device 102 may simultaneously transmit signals using the first technology (e.g., 3G, 4G, IEEE 802.11ac, etc.) and the second technology (e.g., 5G, IEEE 802.11ad, etc.), in which RF exposure is measured using different metrics for the first technology and the second technology (e.g., SAR for the first technology and PD for the second technology). The RF exposure measurements may be performed differently for each transmit scenario and include, for example, electric field measurements using a model of a human body. RF exposure values and/or distributions (simulation and/or measurement) may then be generated per transmit antenna/configuration (beam) on various evaluation surfaces/positions at various locations.

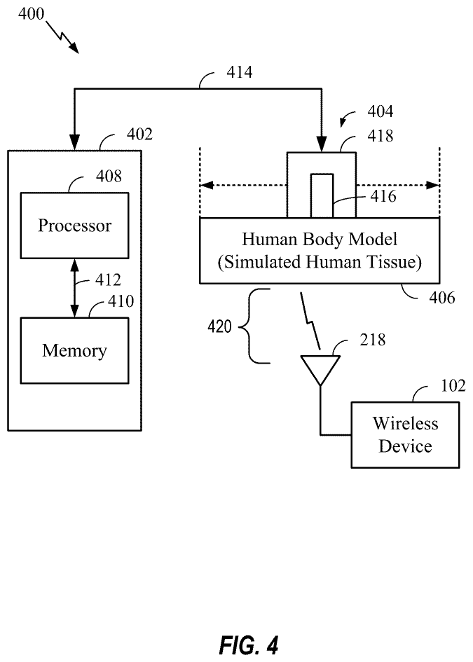

FIG. 4 is a diagram illustrating an example RF exposure measurement system 400 for measuring RF exposure levels (e.g., values and/or distributions) associated with a wireless communication device (e.g., the wireless device 102). As shown, the RF exposure measurement system 400 includes a processing system 402, a (robotic) RF probe 404, and a human body model 406. The RF exposure measurement system 400 may take RF measurements at various transmit scenarios. As used herein, a transmit scenario may correspond to various combinations of radios, communication technologies (e.g., RATs), antennas, antenna groupings, antenna configurations, frequency bands, subbands (e.g., subdivisions of frequency bands), SISO or MIMO transmissions, operating conditions, RF exposure scenarios (e.g., head exposure, body-worn exposure, extremity (hand) exposure, and/or hotspot exposure), device use-case scenarios, physical configurations, and/or geographical locations or regions associated with the wireless device 102. In some examples, these measurements may be used to generate an RF exposure map and determine suitable transmit power limits for the transmit powers of the antenna(s) 218 in compliance with one or more RF exposure limits, as further described herein. The wireless device 102 may emit electromagnetic radiation via the antenna(s) 218 at various transmit powers, and the RF exposure measurement system 400 may take RF measurements via the robotic RF probe 404 (e.g., to determine RF exposure map(s) for the antenna(s) 218). Transmit power limits (e.g., Pₗᵢₘᵢₜₛ) for the various transmit scenarios associated with the wireless device 102 may be determined based on the RF measurements and/or exposure maps. Note that while measurements are described as being performed with respect to the wireless device 102, measurements may be taken with respect to a (different) representative device (e.g., a sample device for testing purposes), and then transmit power limits loaded into or otherwise provided or conveyed to the wireless device 102 (e.g., the devices manufactured for end-users).

In some cases, a test separation distance 420 (or spacing) may be adjusted (increased or decreased) depending on the transmit scenario, where the test separation distance 420 may be the distance between a radiating structure (e.g., the antenna(s) 218) and any part of the human body, in this example, the human body model 406. For example, the test separation distance 420 may be set to 15 millimeters (mm) for body-worn exposure, 0 mm for head exposure, 10 mm for a hotspot exposure, etc. In certain cases, the test separation distance 420 may differ among regions. For example, the test separation distance 420 may be set to 0 mm for body-worn exposure for a particular region, whereas the test separation distance 420 may be set to 15 mm for body-worn exposure for another region, and in some cases, using the same RF exposure limit (e.g., 1.6 W/kg averaged over 1 gram). As the test separation distance 420 may differ among some regions, the corresponding transmit power limits (e.g., Pₗᵢₘᵢₜₛ) may differ among these regions regardless of whether the same RF exposure limit is applied.

The processing system 402 may include a processor 408 coupled to a memory 410 via a bus 412. The processing system 402 may be a computational device such as a computer. The processor 408 may include a microprocessor, a central processing unit (CPU), a graphics processing unit (GPU), a neural networks processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. The processor 408 may be in communication with the robotic RF probe 404 via an interface 414 (such as a computer bus interface), such that the processor 408 may obtain RF measurements taken by the robotic RF probe 404 and control the position of the robotic RF probe 404 relative to the human body model 406, for example.

The memory 410 may be configured to store instructions (e.g., computer-executable code) that when executed by the processor 408, cause the processor 408 to perform various operations. For example, the memory 410 may store instructions for obtaining the RF exposure values or distributions associated with various RF exposure/transmit scenarios and/or adjusting the position of the robotic RF probe 404.

The robotic RF probe 404 may include an RF probe 416 coupled to a robotic arm 418. In some aspects, the RF probe 416 may be a dosimetric probe capable of measuring RF exposures at various frequencies such as sub-6 GHz bands and/or mmWave bands. The RF probe 416 may be positioned by the robotic arm 418 in various locations (as indicated by the dotted arrows) to capture the electromagnetic radiation emitted by the antenna(s) 218 of the wireless device 102. The robotic arm 418 may be a six-axis robot capable of performing precise movements to position the RF probe 416 to the location (on the human body model 406) of maximum electromagnetic field generated by the wireless device 102. In other words, the robotic arm 418 may provide six degrees of freedom in positioning the RF probe 416 with respect to the antenna(s) 218 of the wireless device 102 and/or the human body model 406.

The human body model 406 may be a specific anthropomorphic mannequin with simulated human tissue. For example, the human body model 406 may include one or more liquids that simulate the human tissue of the head, body, and/or extremities. The human body model 406 may simulate the human tissue for determining the maximum permissible transmission power of the antenna(s) 218 in compliance with various RF exposure limits implemented in various regions.

In certain aspects, the RF exposure levels associated with the wireless device 102 may be measured without the human body model 406. For example, the RF probe 416 may be an electric- or magnetic-field probe capable of estimating the SAR and/or PD exposure encountered by human tissue in the free-space surrounding the wireless device 102. While the example depicted in FIG. 4 is described herein with respect to obtaining RF exposure levels with a robotic RF probe to facilitate understanding, aspects of the present disclosure may also be applied to other suitable RF probe architectures, such as using multiple stationary RF probes positioned at various locations along the human body model 406 or free-space.

For a wireless device, a particular Pₗᵢₘᵢₜ may be defined per radio, RAT, frequency band (or carrier, channel, etc.), antenna (or antenna group), antenna configuration, SISO or MIMO transmission, operating condition, RF exposure scenario (e.g., head exposure, body-worn exposure, hand exposure, hotspot exposure, etc.), device use-case scenario, physical configuration, and/or geographical location or region (collectively referred to herein as a “transmit scenario”). In some cases, the RF exposure scenario may correspond to a device state index (DSI) or a particular operational state of the device, where the DSI may indicate the device position relative to a human body, e.g., head, hand, body, etc. In certain cases, Pₗᵢₘᵢₜ may correspond to a particular RF exposure design target (e.g., SAR or PD), where a separate Pₗᵢₘᵢₜ may be determined for each RF exposure distribution (or, more generally, each transmit scenario), for example, as described herein with respect to FIG. 4. As an example, Pₗᵢₘᵢₜₖ for the k^{th} RF exposure distribution may be given by:

$${P}_{limitk} = {Tx}_{k} * RF\_exposure \_design \_target / max ( RF . {exp}_{k} ) \qquad ( 1 )$$

where max(RF.expₖ) is the largest RF exposure value (e.g., SAR value, incident PD value, or absorbed PD value) in the k^{th} RF exposure distribution (RF.expₖ) measured with radio at transmit power Txₖ, Txₖ is the transmit power applied at the antenna while collecting the k^{th} RF exposure distribution, and RF_exposure_design_target may be a target RF exposure limit. In certain cases, RF_exposure_design_target may be lower than the regulatory RF exposure limit to account for device uncertainties and/or to budget enough RF exposure margin to comply with total RF exposure in simultaneous transmission scenarios with other transmitters not included inside the RF exposure time-averaging operation. A regulatory exposure limit may include an RF exposure limit set by a regulatory body (e.g., the FCC) and/or provided by a standards body (e.g., the IEEE or ICNIRP). Thus, the time-averaged RF exposure exhibited by a wireless device may be kept in compliance with the respective regulatory RF exposure limit by maintaining the time-averaged transmit power for the k^{th} RF exposure distribution to less than or equal to Pₗᵢₘᵢₜₖ. Pₗᵢₘᵢₜₖ may vary with radio, technology, operating frequency band, transmitting antenna, antenna configuration, operating condition, physical configuration, geographical location, and/or device position relative to the human body (which may be referred to as “device state index”).

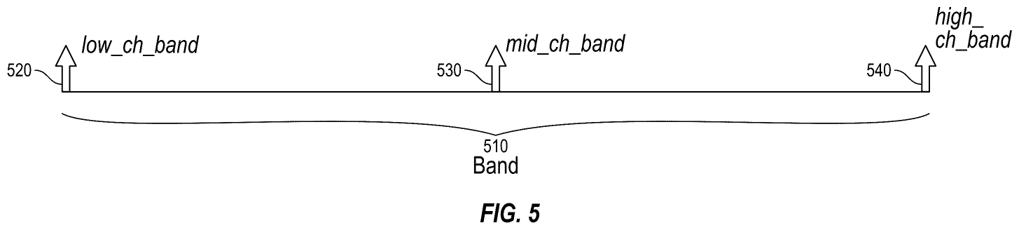

As RF exposure varies with transmit frequency (e.g., operating frequency), it may be infeasible to test RF exposure on all channels of each frequency band per radio, RAT, transmitting antenna, antenna grouping, antenna configuration, SISO or MIMO transmission, operating condition, physical configuration, geographical location, and/or device position supported by the wireless device. As such, certain RF exposure compliance certification processes may allow for testing RF exposure on the lowest, middle, and highest channels of each frequency band per radio, RAT, transmitting antenna, antenna grouping, antenna configuration, SISO or MIMO transmission, operating condition, physical configuration, geographical location, and/or device position supported by the wireless device. Based on the testing, a transmit power limit (e.g., Pₗᵢₘᵢₜ) may be determined based on the worst-case RF exposure (e.g., highest RF exposure) out of the lowest, middle, and highest channels of each frequency band. Referring to FIG. 5, for a given frequency band 510, Pₗᵢₘᵢₜₖ may be given by the following:

$${P}_{limitk} = min \{ {P}_{l imitk\_LowCh} , {P}_{limitk\_MidCh} , {P}_{limitk\_HighCh} \} \qquad ( 2 )$$

where P_{limitk_LowCh} is the transmit power limit for the lowest channel 520 (e.g., low_ch_band) of the frequency band 510, P_{limitk_MidCh} is the transmit power limit for the middle channel 530 (e.g., mid_ch_band) of the frequency band 510, and P_{limitk_HighCh} is the transmit power limit for the highest channel 540 (e.g., high_ch_band) of the frequency band 510.

As noted, in addition to testing the lowest, middle, and highest channels of each frequency band, RF exposure may be evaluated for other combinations of radio configurations (e.g., different bandwidths, resource block (RB) configurations, modulation/waveforms, etc.). Thus, Pₗᵢₘᵢₜₖ for a given frequency band and RAT may be determined based on the minimum value out of all tested radio configurations, e.g., using the following:

$${P}_{limitk} = min \{ {P}_{l imitk \_ 1} , {P}_{l imitk \_ 2} , … , {P}_{limitk\_i} ) \qquad ( 3 )$$

where i=all tested radio configurations for a given RAT, frequency band, antenna, antenna configuration, and device position associated with the wireless device.

In one illustrative, non-limiting, example for WLAN, assume the wireless device supports the following set of WLAN frequency bands:
Industrial, Scientific, and Medical (ISM): 2400˜2483.5
Unlicensed National Information Infrastructure (UNII)-1:5150 MHz˜5250 MHz
UNII-2A: 5250 MHz˜5350 MHz
UNII-2C: 5470 MHz˜5725 MHz
UNII-3:5725 MHz˜5850 MHz
UNII-4:5850 MHz˜5925 MHz
UNII-5:5925 MHz˜6425 MHz
UNII-6:6425 MHz˜6525 MHz
UNII-7:6525 MHz˜6875 MHz
UNII-8:6875 MHz˜7125 MHz.

In the above example, each of the WLAN frequency bands may be tested in multiple radio configurations (including lowest, middle, and highest channels, bandwidth allocation (e.g., resource unit (RU) allocation), modulation/waveform, etc.), and the WLAN frequency bands may be mapped into three Pₗᵢₘᵢₜₛ, WLAN_2.4 GHZ Pₗᵢₘᵢₜ corresponding to WLAN 2.4 GHZ, WLAN_5 GHZ Pₗᵢₘᵢₜ corresponding to WLAN 5 GHZ, and WLAN_6 GHZ Pₗᵢₘᵢₜ corresponding to WLAN 6 GHz, as follows:

$$WLAN\_ 2.4 GHz {P}_{limit} = ISM band$$

$$WLAN\_ 5 GHz {P}_{limit} = \text{} min \{ UNII - 1 , UNII - 2 A , UNII - 2 C , UNII - 3 , UNII - 4 \}$$

$$WLAN\_ 6 GHz {P}_{limit} = min \{ UNII - 5 , UNII - 6 , UNII - 7 , UNII - 8 \}$$

As noted, certain frequency bands may have a wide bandwidth relative to the center frequency. Examples of such bands include FR1 n77 band (e.g., 900 MHz bandwidth from approximately 3300 MHz to 4200 MHz), FR1 n78 band (e.g., 500 MHz bandwidth from approximately 3300 MHz to 3800 MHz), FR1 n79 band (e.g., 600 MHz bandwidth from approximately 4400 MHz to 5000 MHz), WLAN 6 GHz (e.g., 1.2 GHz bandwidth from approximately 5925 MHz to 7125 MHz), and other frequency bands. Depending on the antenna design of the wireless device, there may be a large variation (e.g., on the order of a few decibels (dB)) in the RF exposure of the wireless device between the low frequencies and high frequencies of a given band. Consequently, in some cases, applying a minimum Pₗᵢₘᵢₜ out of all tested frequencies (lowest, middle, and highest channels) of a frequency band may lead to sub-optimal performance (e.g., lower throughput, increased latency, and/or lower transmission range) when the wireless device is operating at frequencies associated with a higher Pₗᵢₘᵢₜ.

As also noted, in certain cases, applying a minimum Pₗᵢₘᵢₜ for an entire frequency band can impact design criteria (or specifications) for antennas and/or RF circuitry of a wireless device, notwithstanding the amount of RF exposure variation in the frequency band and/or whether the frequency band has a large bandwidth relative to the center frequency.

### Example Radio Frequency Exposure Compliance Using Subband Radio Frequency Limits

Aspects of the present disclosure provide apparatus and methods for RF exposure compliance using transmit power limits (e.g., Pₗᵢₘᵢₜ) defined on a subband level. A respective transmit power limit (Pₗᵢₘᵢₜ) may be determined for each subband of a frequency band for each transmit scenario. The techniques described herein may be used for various frequency bands, including wide frequency bands (e.g., frequency bands that have a wide bandwidth (larger than a threshold) relative to the center frequency of the frequency band), narrow frequency bands (e.g., frequency bands that have a narrow bandwidth (less than a threshold) relative to the center frequency of the frequency band), cellular bands, and WLAN bands, among others. The transmit scenario may correspond to various combinations of radios, communication technologies (e.g., RATs), antennas, antenna groupings, antenna configurations (or beams) (e.g., transmit beam configuration), SISO or MIMO transmissions, operating conditions, frequency bands, channels, RF exposure scenarios (e.g., head exposure, body-worn exposure, extremity (hand) exposure, and/or hotspot exposure), device use-case scenarios, physical configurations of a device, and/or geographical locations or regions, as illustrative, non-limiting examples.

In certain aspects, the wireless device may implement a time-averaging operation based at least in part on the subband-based transmit power limit(s). For example, the wireless device may monitor the operating transmit frequency and channel bandwidth to determine the applicable subband transmit power limit to use as the maximum time-averaged transmit power limit.

In certain aspects, the determination of whether to define and/or apply a subband transmit power limit may be based on the RF exposure variation within a frequency band (including the subband). For example, for a frequency band that has a small amount of RF exposure variation (e.g., below a threshold amount of RF exposure variation, measured in dB or some other metric) between the lowest frequencies and highest frequencies, a transmit power limit(s) defined for subband(s) of the frequency band may not be determined or applied as part of a time-averaging operation. In these cases, the time-averaging operation may instead utilize the transmit power limit determined for the frequency band (e.g., minimum Pₗᵢₘᵢₜ out of Pₗᵢₘᵢₜₛ for the lowest, middle, and highest channels of the frequency band). On the other hand, for a frequency band that has a large amount of RF exposure variation (e.g., above a threshold amount of RF exposure variation, measured in dB or some other metric) between the lowest frequencies and highest frequencies, a transmit power limit(s) may be determined for subband(s) of the frequency band and applied as part of a time-averaging operation.

In certain aspects, RF exposure may be evaluated for the lowest, middle, and highest frequencies (or channels) of a given subband for each transmit scenario. Based on the RF exposure, a respective Pₗᵢₘᵢₜ may be determined for the lowest frequency, middle frequency, and highest frequency of the subband. The Pₗᵢₘᵢₜ for a given subband within a frequency band may be determined by setting the subband Pₗᵢₘᵢₜ to the minimum of the Pₗᵢₘᵢₜₛ for the lowest frequency (or channel) of the subband, middle frequency (or channel) of the subband, and the highest frequency (or channel) of the subband for a given transmit scenario (e.g., radio, technology, frequency band, antenna, antenna grouping, antenna configuration, SISO or MIMO transmission, device use-case scenario, physical configuration of the device, geographical location, device position, etc.). Note that while certain aspects herein describe determining a subband Pₗᵢₘᵢₜ based on the minimum of 3 Pₗᵢₘᵢₜₛ corresponding to the lowest, middle, and highest frequencies of the subband, in certain aspects, the subband Pₗᵢₘᵢₜ may be determined based on less than 3 Pₗᵢₘᵢₜₛ or more than 3 Pₗᵢₘᵢₜₛ. For example, in general, the set of Pₗᵢₘᵢₜₛ used for the determination of the subband Pₗᵢₘᵢₜ may be associated with any frequencies (or channels) within the subband (which may or may not include the lowest, middle, and/or highest frequencies of the subband).

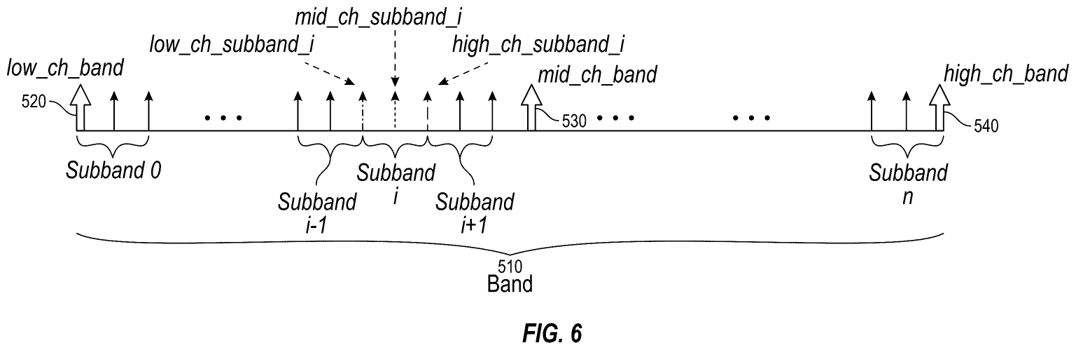

Consider the scenario depicted in FIG. 6, which illustrates one or more subbands (e.g., subband 0 to subband n) defined within a frequency band 510, according to certain aspects of the present disclosure. Here, for a given transmit scenario, the transmit power limit for a subband i (where i∈{0, n}) may be given by the following:

$${P}_{limit\_subband \_i} = \text{} min \{ {P}_{limit\_low \_ch \_subband \_i} , {P}_{limt\_mid \_ch \_subband \_i} , {P}_{limit\_high \_ch \_subband \_i} \} , \qquad ( 4 )$$

out of all radio configurations (e.g., modulation, bandwidth, RBs, etc.) supported by the wireless device.

In some cases, if the bandwidth of the low or high channel spreads across the boundary of the defined subband i, then P_{limit_low_ch_subband_i} and P_{limit_high_ch_subband_i} in (4) may be defined according to (5) and (6), respectively:

$${P}_{limit\_low \_ch \_subband \_i} = \text{} min ( {P}_{limit\_high \_ch \_subband \_ ( i - 1 )} , {P}_{limit\_low \_ch \_subband \_i} \} \qquad ( 5 )$$

$${P}_{limit\_high \_ch \_subband \_i} = \text{} min \{ {P}_{limit\_high \_ch \_subband \_i} , {P}_{limt\_low \_ch \_subband \_ ( i + 1 )} \} \qquad ( 6 )$$

In certain aspects, the RF exposure evaluation (and corresponding Pₗᵢₘᵢₜ determination) may be performed on a frequency band level, subband level, or a combination thereof. For example, in some cases, RF exposure may be evaluated at the lowest, middle, and highest channels of a frequency band according to RF exposure compliance certification processes specified in the FCC knowledge database (KDB). Additionally or alternatively, for certain frequency bands (e.g., FR1 n77 band), RF exposure may be evaluated for one or more subbands of the frequency band (assuming the subband has been defined or characterized).

In certain aspects, the subband Pₗᵢₘᵢₜ for a given subband may be based on the RF exposure evaluation performed at the frequency band level, subband level, or a combination thereof. That is, an operator (e.g., original equipment manufacturer (OEM)) may perform additional RF exposure evaluation on subband(s) to determine the subband P limits or use the RF exposure evaluation performed for the frequency band (that includes the subband(s)) to determine the subband Pₗᵢₘᵢₜₛ. With reference to FIG. 6, for example, if subband i is characterized (or defined), then P_{limit_subband_i} may be determined using (4)-(6). If subband i is uncharacterized (or undefined), then P_{limit_subband_i} may be determined using (2)-(3).

With reference to FIG. 6, in certain aspects, one or more parameters of the subbands within the frequency band 510 may be configurable (e.g., by an original equipment manufacturer (OEM)), based on RAT, frequency band, antenna, antenna configuration, device position (e.g., DSI), RF chains, antenna design, Pₗᵢₘᵢₜ variation for the antenna design, network deployment frequencies, and other criteria, as illustrative, non-limiting examples. Such subband parameters may include a frequency range, number of subbands, starting (lowest) frequency, ending (highest) frequency, and any combination thereof.

In some cases, for example, the number of subbands may be based in part on the amount of RF exposure variation (and hence, Pₗᵢₘᵢₜ variation) between the lowest and highest channels 520, 540 of the frequency band 510. In one illustrative, non-limiting, example, if there is a 10 dB variation in RF exposure/Pₗᵢₘᵢₜ between the lowest and highest channels 520, 540 of the frequency band 510, then 10 subbands each with a 1 dB variation in RF exposure/Pₗᵢₘᵢₜ may be defined within the frequency band 510. Note, however, that is merely an example and that any number of subbands may be defined within the frequency band 510 based on any combination of criteria described herein. For example, subbands having unequal power or exposure variation, bandwidth, etc. may be defined and/or used. In general, a larger number of subbands may be defined within the frequency band 510 for a large amount of variation in RF exposure/Pₗᵢₘᵢₜ between the lowest and highest channels 520, 540 of the frequency band 510, and a smaller number of subbands (or even zero subbands) may be defined within the frequency band 510 for a small amount of variation in RF exposure/Pₗᵢₘᵢₜ between the lowest and highest channels 520, 540 of the frequency band 510.

In certain aspects, the subbands within frequency band 510 may be contiguous, non-contiguous, overlapping, non-overlapping, etc. For example, at least one first subband within frequency band 510 may be contiguous with at least another second subband within frequency band 510. In another example, at least one first subband within frequency band 510 may be non-contiguous with at least another second subband within frequency band 510. In yet another example, at least one first subband within frequency band 510 may be overlapping with at least another second subband within frequency band 510. In yet another example, at least one first subband within frequency band 510 may be non-overlapping with at least another second subband within frequency band 510.

In certain aspects, each antenna of a wireless device may have a respective subband definition within a given frequency band (e.g., frequency band 510). Using frequency band 510 in FIG. 6 as a reference example, for a wireless device that includes antenna ‘1’ and antenna ‘2,’ antenna ‘1’ may use a first configuration of subband(s) within the frequency band 510, and antenna ‘2’ may use a second configuration of subband(s) within the frequency band 510. Here, at least one parameter (e.g. number of subbands, frequency range(s) of subband(s), etc.) of the first and second subband configurations may be different. In other examples, a subband configuration may be defined for an antenna or module group.

In certain aspects, the subband definition may vary for a given MIMO antenna pair of the wireless device. For example, assume wireless device supports one or more MIMO antenna pairs (x,y) with antenna ‘x’ and antenna ‘y.’ Here, for a given MIMO antenna pair (x,y), the subband definition (or subband configuration) within frequency band 510 may be different than another subband definition (or subband configuration) within frequency band 510 for another MIMO antenna pair of the wireless device. Similarly, the subband definition for an antenna (e.g., antenna ‘x’) may be different when that antenna is transmitting via MIMO than when the antenna is transmitting with a non-MIMO configuration.

In certain aspects, the subband Pₗᵢₘᵢₜₛ for each transmit scenario may be loaded into or otherwise provided or conveyed to the wireless device 102. In some cases, the subband Pₗᵢₘᵢₜₛ may be in the form of a look-up table (or other data structure) (including one or more values of Pₗᵢₘᵢₜ depending on the transmit scenario).

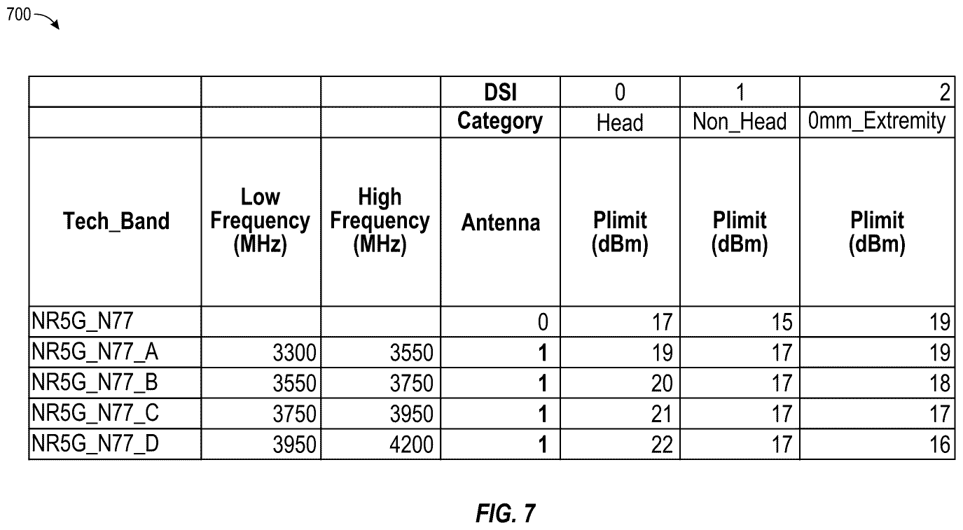

FIG. 7 is a diagram illustrating an example data structure 700 for selecting a subband Pₗᵢₘᵢₜ for a time-averaging operation, according to certain aspects of the present disclosure. The data structure 700 may be stored in the memory of a wireless device, such as the memory 240. In some aspects, the data structure 600 may be converted and/or compressed to a computer-readable dataset format, such as SQLite, JavaScript Object Notation (JSON), Extensible Markup Language (XML), or any other suitable dataset format. The data structure 700 may be generated by an RF exposure measurement system (e.g., RF exposure measurement system 400). In certain aspects, the data structure 700 may be generated as part of an RF exposure compliance certification procedure.

Here, the data structure 700 includes an indication of a respective Pₗᵢₘᵢₜ for each subband, antenna, and DSI. Although not shown, note that the data structure 700 may indicate a respective Pₗᵢₘᵢₜ for any combination of transmit scenarios (e.g., radio, RAT, frequency band, subband, antenna, antenna grouping, antenna configuration, operating condition, physical configuration, device use-case scenario, geographical location, DSI, etc.). In certain aspects, the data structure 700 may allow an operator to enter a Pₗᵢₘᵢₜ for an entire frequency band (e.g., antenna ‘0’ in NR5G_N77) or enter a respective Pₗᵢₘᵢₜ per subband (e.g., antenna ‘1’ in NR5G_N77_A, NR5G_N77_B, NR5G_N77_C, and NR5G_N77_D).

In certain aspects, if Pₗᵢₘᵢₜ is evaluated for the entire frequency band, as opposed to for a given transmit scenario, then that Pₗᵢₘᵢₜ can be included within the data structure 700 for each of the subbands (assuming RF exposure is not evaluated per subband). That is, for a given antenna, if the Pₗᵢₘᵢₜₛ vary significantly among subbands in one DSI (e.g., head DSI #0 for antenna ‘1’), but not in other DSIs (e.g., body-worn DSI #1 for antenna ‘1’), then Pₗᵢₘᵢₜₛ can be included per subband in selected DSIs (e.g., DSI #0 and DSI #2 of antenna ‘1’), whereas for other DSIs (e.g., DSI #1 for antenna ‘1’), the entire-band Pₗᵢₘᵢₜ may be included for each of the subbands. It will be appreciated that other data structures or methods of storing or accessing Pₗᵢₘᵢₜ per subband may be utilized. As an example, while the configuration in FIG. 7 illustrates a data structure in which the subbands are the same for DSI #s 0-2, a data structure in which the subbands may vary between DSIs may be implemented. In other examples, a region of the body or location on the body which is more specific than designated by a DSI (e.g., left side of head) may be used in the data structure in addition to or instead of the DSI.

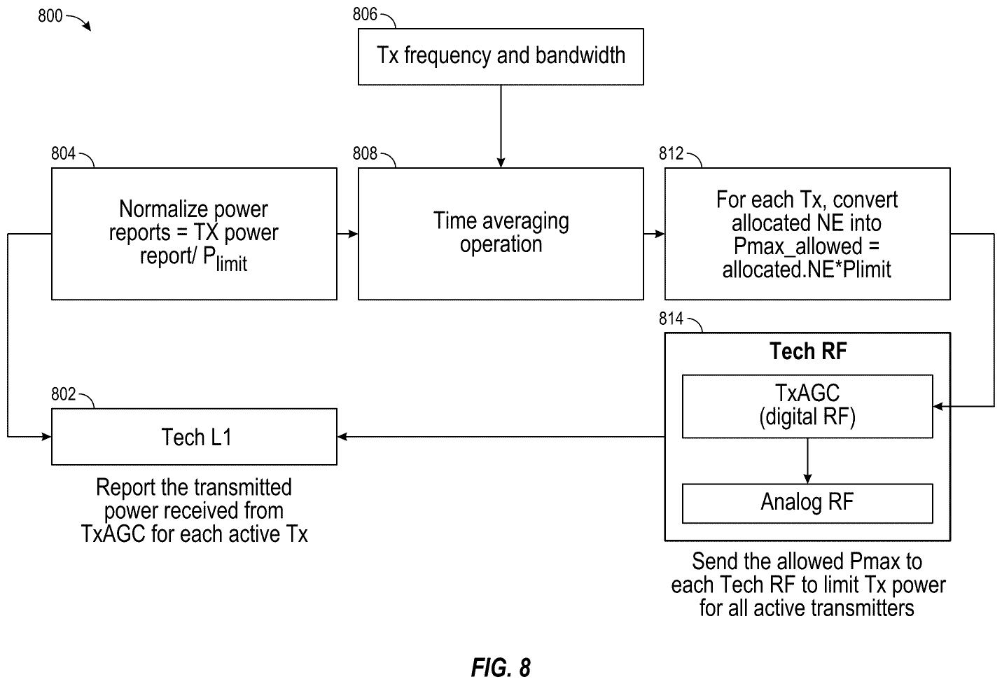

FIG. 8 is a flow diagram illustrating example operations 800 for managing a time-averaged RF exposure evaluation using subband transmission power limits (Pₗᵢₘᵢₜₛ). The operations 800 may be performed, for example, by a wireless device (e.g., the UE 120a).

The operations 800 may optionally begin, at block 802, where the wireless device may obtain the transmit power used for a particular time interval (e.g., a second time interval 608) in a running time window (T) associated with a time-averaged RF exposure limit. The transmit power may be obtained from a transmit automatic gain control (TxAGC) module at Layer-1 (L1) of a protocol stack. For example, L1 may include the physical radio layer (PHY) of the protocol stack. In certain aspects, the processor 210 and/or modem 212 of the wireless device 102 may obtain (or access) the transmit power used for the particular time interval. The processor 210 and/or modem 212 may include the TxAGC module and track the transmit power output by the transmit path over time. A transmit power report of the past transmit powers may be representative of actual transmit power(s) within an expected device uncertainty.

At block 804, the wireless device may determine a normalized power report of past transmit powers. The normalized power report for a particular time interval may be a past time-averaged transmit power during a time interval normalized using Pₗᵢₘᵢₜ. For example, the normalized power report may be equal to the past time-averaged transmit power(s) divided by Pₗᵢₘᵢₜ (e.g., Normalized Power Report=Tx Power Report/Pₗᵢₘᵢₜ), where the transmit power(s) associated with the particular time interval are averaged over that time interval. Such normalized power reports may be computed and tracked for multiple time intervals (e.g., corresponding to the past transmit powers) belonging to a running time window (T). The wireless device may determine an average of the normalized power reports associated with the past transmit powers.

At block 806, the wireless device may determine a current operating transmit frequency and bandwidth for transmission of a signal, and obtain an indication of a Pₗᵢₘᵢₜ associated with the operating transmit frequency and bandwidth. For example, the wireless device may continually monitor the operating transmit frequency and channel bandwidth and select the suitable Pₗᵢₘᵢₜ depending on the transmit scenario. In certain aspects, the suitable Pₗᵢₘᵢₜ may be a subband Pₗᵢₘᵢₜ determined using one or more techniques described herein.

At block 808, the wireless device may perform a time-averaging operation based on the Pₗᵢₘᵢₜ obtained in block 806. The wireless device may determine a normalized exposure (NE) margin allowed for the next time interval in the time window (T) such that the time average of the normalized power report and the exposure margin for the next time interval satisfy the time-averaged RF exposure limit. In certain aspects, the exposure margin may be the maximum RF exposure that the wireless device can produce and satisfy the time-averaged RF exposure limit. The normalized exposure margin may be the percentage of exposure remaining with respect to the normalized power report and the time-averaged RF exposure limit. For example, the time-averaged RF exposure limit may be satisfied when the time average of the normalized power report and the exposure margin for the next time interval is less than or equal to one (e.g., the normalized RF exposure limit). In terms of the allowable transmit power for the next time interval, the normalized exposure margin represents the percentage of the maximum time-averaged RF exposure power level Pₗᵢₘᵢₜ.

At block 812, the wireless device may determine the maximum allowed transmit power (Pₘₐₓ allowed) for the next time interval. For example, the maximum allowed transmit power (Pₘₐₓ allowed) may be equal to the product of the normalized exposure margin determined at block 808 and Pₗᵢₘᵢₜ.

At block 814, the wireless device may provide the maximum allowed transmit power to transceiver circuitry (e.g., the transceiver depicted in FIG. 2). For example, the TxAGC module may obtain the maximum allowed transmit power as digital RF information (e.g., a particular gain index associated with an output power of the transmit path depicted in FIG. 2), and the TxAGC module may control the gains applied to circuitry in the transmit path to output a signal (e.g., an analog RF signal) at the transmit power associated with the digital RF information.

Note, in certain aspects, if the wireless device determines that the channel bandwidth straddles multiple subbands (e.g., two or more subbands), then the wireless device (at block 806) may set the Pₗᵢₘᵢₜ used by the time-averaging operation to the minimum of the subband Pₗᵢₘᵢₜₛ for the multiple subbands. For example, with reference to FIG. 7, if the wireless device is operating at 3750 MHz with a 100 MHz bandwidth in the FR1 n77 band, then the Pₗᵢₘᵢₜ used by the time-averaging operation may be set to min {Pₗᵢₘᵢₜ for NR5G_N77_B, Pₗᵢₘᵢₜ for NR5G_N77_C}.

### Example Operations for Wireless Communications

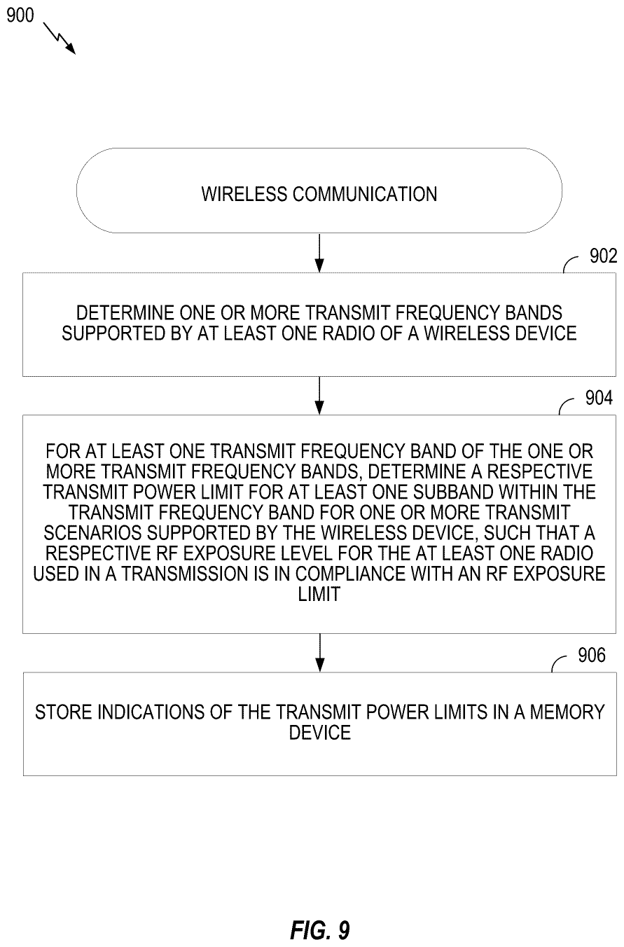

FIG. 9 is a flow diagram illustrating example operations 900 for wireless communication. The operations 900 may be performed, for example, by a processing system (e.g., the processing system 402 of FIG. 4) and/or an RF exposure measurement system (e.g., the RF exposure measurement system 400 of FIG. 4). The operations 900 may be implemented as software components that are executed and run on one or more processors (e.g., the processor 408 of FIG. 4, etc.).

The operations 900 may involve, at block 902, determining one or more transmit frequency bands supported by at least one radio of a wireless device.

The operations 900 may also involve, at block 904, for at least one transmit frequency band of the one or more transmit frequency bands, determining a respective transmit power limit for at least one subband within the transmit frequency band for one or more transmit scenarios supported by the wireless device, such that a respective RF exposure level for the at least one radio used in a transmission is in compliance with an RF exposure limit.

The operations 900 may further involve, at block 906, storing indications of the transmit power limits in a memory device (e.g., the memory 240).

In certain aspects, determining the respective transmit power limit for the at least one subband may include: (i) determining a plurality of representative transmit power limits for a respective plurality of frequencies within a particular subband; and (ii) setting the respective transmit power limit for the particular subband to a minimum of the plurality of representative transmit power limits. In some such aspects, the indications of the transmit power limits may include indications of the plurality of representative transmit power limits for each particular subband. Additionally or alternatively, in some such aspects, the plurality of frequencies may include at least one of a lowest frequency of the particular subband, a middle frequency of the particular subband, or a highest frequency of the particular subband.

In certain aspects, determining the respective transmit power limit for the at least one subband may include determining an amount of RF exposure associated with the at least one radio for the at least one subband.

In certain aspects, the at least one subband may include multiple subbands. In some such aspects, a number of the multiple subbands in the transmit frequency band may be based on the amount of RF exposure variation in the transmit frequency band.

In certain aspects, the at least one subband may include a first subband and a second subband. In some such aspects, the first subband may be contiguous with respect to the second subband. In other such aspects, the first subband may be non-overlapping with respect to the second subband.

In certain aspects, the operations 900 may further involve: (i) determining a first configuration of the at least one subband to be applied when the wireless device operates according to a first transmit scenario of the one or more transmit scenarios; and (ii) determining a second configuration of the at least one subband to be applied when the wireless device operates according to a second transmit scenario of the one or more transmit scenarios.

In certain aspects, the RF exposure limit may be a time-averaged RF exposure limit.

In certain aspects, an amount of RF exposure variation in the at least one transmit frequency band may be greater than a threshold. For example, in certain aspects, for each transmit frequency band of the one or more transmit frequency bands having an amount of RF exposure variation greater than the threshold, a respective transmit power limit may be determined for at least one subband within the transmit frequency band for one or more transmit scenarios supported by the wireless device, such that a respective RF exposure level for the at least one radio used in a transmission is in compliance with an RF exposure limit.

Note that while operations 900 are described as being performed by an RF exposure measurement system (or by one or more hardware/software components thereof), in certain aspects, the operations 900 may be performed by a wireless device, such as the wireless device 102 in the wireless communication system 100. In such aspects, the operations 900 may be implemented as software components that are executed and run on one or more processors (e.g., the processor 210 and/or the modem 212 of FIG. 2) of the wireless device.

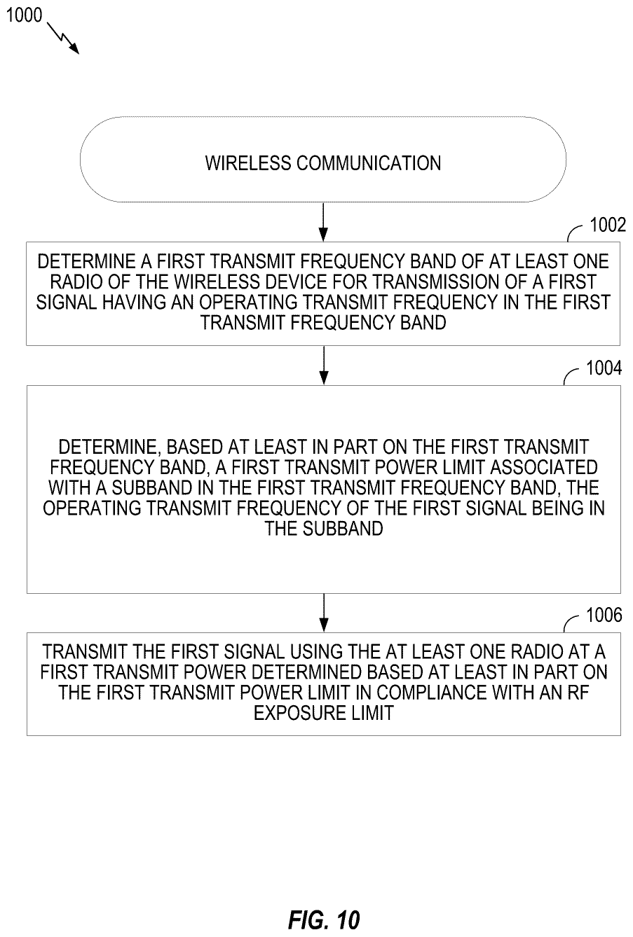

FIG. 10 is a flow diagram illustrating example operations 1000 for wireless communication. The operations 1000 may be performed, for example, by a wireless device (e.g., the wireless device 102 in the wireless communication system 100). The operations 1000 may be implemented as software components that are executed and run on one or more processors (e.g., the processor 210 and/or the modem 212 of FIG. 2). Further, the transmission and/or reception of signals by the wireless device in the operations 1000 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 1000 may optionally begin, at block 1002, where the wireless device determines a first transmit frequency band (e.g., frequency band 510) of at least one radio of the wireless device for transmission of a first signal having an operating transmit frequency in the first transmit frequency band.

At block 1004, the wireless device, in response to determining that the amount of RF exposure variation in the first transmit frequency band is greater than the first threshold, determines, based at least in part on the first transmit frequency band, a first transmit power limit associated with a subband in the first transmit frequency band, the operating transmit frequency of the first signal being in the subband.

At block 1006, the wireless device transmits the first signal using the at least one radio at a first transmit power determined based at least in part on the first transmit power limit in compliance with an RF exposure limit.

In certain aspects, the first transmit power limit may be further determined based at least in part on a transmit scenario for the wireless device.

In certain aspects, determining the first transmit power limit associated with the subband may include accessing a stored indication of the first transmit power limit.

In certain aspects, the operations 1000 may further include determining, from a plurality of subbands in the first transmit frequency band, the subband based on the operating transmit frequency and an operating bandwidth of the first signal. In some such aspects, the operating bandwidth may overlap at least a first subband and a second subband of the plurality of subbands. Additionally, in some such aspects, determining the first transmit power limit associated with the subband may include: determining a transmit power limit associated with the first subband; determining a transmit power limit associated with the second subband; and setting the first transmit power limit to a value based on the transmit power limit associated with the first subband and the transmit power limit associated with the second subband.

In certain aspects, the operations 1000 may further include: determining a second transmit frequency band of the at least one radio of the wireless device for transmission of a second signal having an operating transmit frequency in the second transmit frequency band; determining, based at least in part on the second transmit frequency band, a second transmit power limit associated with the second transmit frequency band; and transmitting the second signal using the at least one radio at a second transmit power determined based at least in part on the second transmit power limit in compliance with the RF exposure limit. In some such aspects, an amount of RF exposure variation in the second transmit frequency band may be less than a threshold.

In certain aspects, the RF exposure limit may be a time-averaged RF exposure limit.

In certain aspects, the subband may include multiple frequencies in the first transmit frequency band.

In certain aspects, an amount of RF exposure variation in the first transmit frequency band may be greater than a threshold.

### Example Communications Device

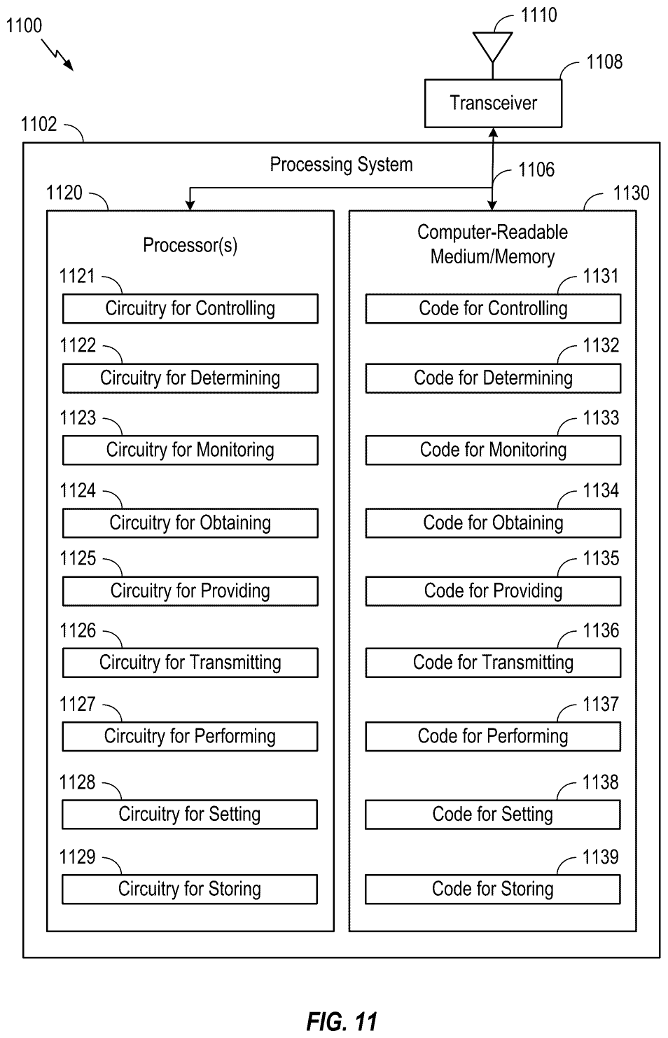

FIG. 11 depicts aspects of an example communications device 1100. In some aspects, communications device 1100 is a wireless communication device, such as the wireless device 102 described above with respect to FIGS. 1 and 2.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of any of the processor 210 and/or the modem 212, as described with respect to FIG. 2. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the operations 500 described with respect to FIG. 5, the operations 900 described with respect to FIG. 9, the operations 1000 described with respect to FIG. 10, and/or any aspect related to the operations described herein. Note that reference to a processor performing a function of communications device 1100 may include one or more processors performing that function of communications device 1100.

In the depicted example, computer-readable medium/memory 1130 stores code (e.g., executable instructions) for controlling 1131 (including code for operating, code for refraining, and code for ceasing), code for determining 1132 (including code for detecting and code for accessing), code for monitoring 1133, code for obtaining 1134, code for providing 1135, code for transmitting 1136, code for performing 1137, code for setting 1138, and code for storing 1139. Processing of the code 1131-1139 may cause the communications device 1100 to perform the operations 500 described with respect to FIG. 5, the operations 900 described with respect to FIG. 9, the operations 1000 described with respect to FIG. 10, and/or any aspect related to operations described herein.

The one or more processors 1120 include circuitry configured to implement (e.g., execute) the code stored in the computer-readable medium/memory 1130, including circuitry for controlling 1121 (including circuitry for operating, circuitry for ceasing, and circuitry for refraining), circuitry for determining 1122 (including circuitry for detecting and circuitry for accessing), circuitry for monitoring 1123, circuitry for obtaining 1124, circuitry for providing 1125, circuitry for transmitting 1126, circuitry for performing 1127, circuitry for setting 1128. And circuitry for storing 1129 Processing with circuitry 1121-1129 may cause the communications device 1100 to perform the operations 500 described with respect to FIG. 5, the operations 900 described with respect to FIG. 9, the operations 1000 described with respect to FIG. 10, and/or any aspect related to operations described herein.

Various components of the communications device 1100 may provide means for performing the operations 500 described with respect to FIG. 5, the operations 900 described with respect to FIG. 9, the operations 1000 described with respect to FIG. 10, and/or any aspect related to operations described herein. For example, means for transmitting, sending or outputting for transmission may include the TX path 214 and/or antenna(s) 218 of the wireless device 102 illustrated in FIG. 2 and/or transceiver 1108 and antenna 1110 of the communications device 1100 in FIG. 11. Means for receiving or obtaining may include the RX path 216 and/or antenna(s) 218 of the wireless device 102 illustrated in FIG. 2, and/or transceiver 1108 and antenna 1110 of the communications device 1100 in FIG. 11. Means for controlling, means for performing, means for storing, means for operating, means for ceasing, means for refraining, means for determining, means for detecting, means for monitoring, means for comparing, means for obtaining, means for setting, means for accessing, and/or means for providing may include a processor, such as the processor 210 and/or modem 212 depicted in FIG. 2 and/or the processor(s) 1120 in FIG. 11.

### Example Aspects

Implementation examples are described in the following numbered clauses:

Clause 1: A method of wireless communication by a wireless device, comprising: determining a first transmit frequency band of at least one radio of the wireless device for transmission of a first signal having an operating transmit frequency in the first transmit frequency band; determining, based at least in part on the first transmit frequency band, a first transmit power limit associated with a subband in the first transmit frequency band, the operating transmit frequency of the first signal being in the subband; and transmitting the first signal using the at least one radio at a first transmit power determined based at least in part on the first transmit power limit in compliance with a radio frequency (RF) exposure limit.

Clause 2: The method of Clause 1, wherein the first transmit power limit is further determined based at least in part on a transmit scenario for the wireless device.

Clause 3: The method in accordance with any of Clauses 1-2, wherein determining the first transmit power limit associated with the subband comprises accessing a stored indication of the first transmit power limit.

Clause 4: The method in accordance with any of Clauses 1-3, further comprising determining, from a plurality of subbands in the first transmit frequency band, the subband based on the operating transmit frequency and an operating bandwidth of the first signal.

Clause 5: The method of Clause 4, wherein: the operating bandwidth overlaps at least a first subband and a second subband of the plurality of subbands; and determining the first transmit power limit associated with the subband comprises: determining a transmit power limit associated with the first subband; determining a transmit power limit associated with the second subband; and setting the first transmit power limit to a value based on the transmit power limit associated with the first subband and the transmit power limit associated with the second subband.

Clause 6: The method in accordance with any of Clauses 1-5, further comprising: determining a second transmit frequency band of the at least one radio of the wireless device for transmission of a second signal having an operating transmit frequency in the second transmit frequency band; determining, based at least in part on the second transmit frequency band, a second transmit power limit associated with the second transmit frequency band; and transmitting the second signal using the at least one radio at a second transmit power determined based at least in part on the second transmit power limit in compliance with the RF exposure limit.

Clause 7: The method in accordance with any of Clauses 1-6, wherein the RF exposure limit is a time-averaged RF exposure limit.

Clause 8: The method in accordance with any of Clauses 1-7, wherein the subband comprises a plurality of frequencies in the first transmit frequency band.

Clause 9: A method of wireless communications, comprising: determining one or more transmit frequency bands supported by at least one radio of a wireless device; for at least one transmit frequency band of the one or more transmit frequency bands, determining a respective transmit power limit for at least one subband in the at least one transmit frequency band for one or more transmit scenarios supported by the wireless device, such that a respective radio frequency (RF) exposure level for the at least one radio used in a transmission is in compliance with an RF exposure limit; and storing indications of the transmit power limits in a memory device.

Clause 10: The method of Clause 9, wherein determining the respective transmit power limit for the at least one subband comprises: determining a plurality of representative transmit power limits for a respective plurality of frequencies within a particular subband; and setting the respective transmit power limit for the particular subband to a minimum of the plurality of representative transmit power limits.

Clause 11: The method of Clause 10, wherein the indications of the transmit power limits comprise indications of the plurality of representative transmit power limits for each particular subband.

Clause 12: The method in accordance with any of Clauses 10-11, wherein the plurality of frequencies comprises at least one of a lowest frequency of the particular subband, a middle frequency of the particular subband, or a highest frequency of the particular subband.

Clause 13: The method in accordance with any of Clauses 9-12, wherein determining the respective transmit power limit for the at least one subband comprises determining an amount of RF exposure associated with the at least one radio for the at least one subband.

Clause 14: The method in accordance with any of Clauses 9-13, wherein the at least one subband comprises multiple subbands and wherein a number of the multiple subbands in the at least one transmit frequency band is based on an amount of RF exposure variation in the at least one transmit frequency band.

Clause 15: The method in accordance with any of Clauses 9-14, wherein the at least one subband comprises a first subband and a second subband and wherein the first subband is contiguous with respect to the second subband.

Clause 16: The method in accordance with any of Clauses 9-15, wherein the at least one subband comprises a first subband and a second subband and wherein the first subband is non-overlapping with respect to the second subband.

Clause 17: The method in accordance with any of Clauses 9-16, further comprising: determining a first configuration of the at least one subband to be applied when the wireless device operates according to a first transmit scenario of the one or more transmit scenarios; and determining a second configuration of the at least one subband to be applied when the wireless device operates according to a second transmit scenario of the one or more transmit scenarios.

Clause 18: The method in accordance with any of Clauses 9-17, wherein the RF exposure limit is a time-averaged RF exposure limit.

Clause 19: The method in accordance with any of Clauses 9-18, wherein an amount of RF exposure variation in the at least one transmit frequency band is greater than a threshold.

Clause 20: An apparatus comprising: one or more memories collectively storing computer-executable instructions, and one or more processors coupled to the one or more memories, the one or more processors being collectively configured to execute the computer-executable instructions to cause the apparatus to perform a method in accordance with any of Clauses 1-8.

Clause 21: An apparatus for wireless communication, comprising means for performing a method in accordance with any of Clauses 1-8.

Clause 22: A non-transitory computer-readable medium comprising computer-executable instructions that, when collectively executed by one or more processors of a processing system, cause the processing system to perform a method in accordance with any of Clauses 1-8.

Clause 23: A computer program product embodied on a computer-readable storage medium comprising code for performing a method in accordance with any of Clauses 1-8.

Clause 24: An apparatus comprising: one or more memories collectively storing computer-executable instructions, and one or more processors coupled to the one or more memories, the one or more processors being collectively configured to execute the computer-executable instructions to cause the apparatus to perform a method in accordance with any of Clauses 9-19.

Clause 25: An apparatus for wireless communication, comprising means for performing a method in accordance with any of Clauses 9-19.

Clause 26: A non-transitory computer-readable medium comprising computer-executable instructions that, when collectively executed by one or more processors of a processing system, cause the processing system to perform a method in accordance with any of Clauses 9-19.

Clause 27: A computer program product embodied on a computer-readable storage medium comprising code for performing a method in accordance with any of Clauses 9-19.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIGS. 5 and 9).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
determining a first transmit frequency band of at least one radio of the wireless device for transmission of a first signal having an operating transmit frequency in the first transmit frequency band;
determining, based at least in part on the first transmit frequency band, a first transmit power limit associated with a subband in the first transmit frequency band, the operating transmit frequency of the first signal being in the subband; and
transmitting the first signal using the at least one radio at a first transmit power determined based at least in part on the first transmit power limit in compliance with a radio frequency (RF) exposure limit.

2. The method of claim 1, wherein the first transmit power limit is further determined based at least in part on a transmit scenario for the wireless device.

3. The method of claim 1, wherein determining the first transmit power limit associated with the subband comprises accessing a stored indication of the first transmit power limit.

4. The method of claim 1, further comprising determining, from a plurality of subbands in the first transmit frequency band, the subband based on the operating transmit frequency and an operating bandwidth of the first signal.

5. The method of claim 4, wherein:
the operating bandwidth overlaps at least a first subband and a second subband of the plurality of subbands; and
determining the first transmit power limit associated with the subband comprises:
determining a transmit power limit associated with the first subband;
determining a transmit power limit associated with the second subband; and
setting the first transmit power limit to a value based on the transmit power limit associated with the first subband and the transmit power limit associated with the second subband.

6. The method of claim 1, further comprising:
determining a second transmit frequency band of the at least one radio of the wireless device for transmission of a second signal having an operating transmit frequency in the second transmit frequency band;
determining, based at least in part on the second transmit frequency band, a second transmit power limit associated with the second transmit frequency band; and
transmitting the second signal using the at least one radio at a second transmit power determined based at least in part on the second transmit power limit in compliance with the RF exposure limit.

7. The method of claim 1, wherein the RF exposure limit is a time-averaged RF exposure limit.

8. The method of claim 1, wherein the subband comprises a plurality of frequencies in the first transmit frequency band.

9. An apparatus for wireless communication, comprising:
one or more memories collectively storing computer-executable instructions; and
one or more processors coupled to the one or more memories, the one or more processors being collectively configured to execute the computer-executable instructions to cause the apparatus to:
determine a transmit frequency band of at least one radio of the apparatus for transmission of a signal having an operating transmit frequency in the transmit frequency band;
determine, based at least in part on the transmit frequency band, a transmit power limit associated with a subband in the transmit frequency band, the operating transmit frequency of the signal being in the subband; and
transmit the signal using the at least one radio at a transmit power determined based at least in part on the transmit power limit in compliance with a radio frequency (RF) exposure limit.

10. A method of wireless communications, comprising:
determining one or more transmit frequency bands supported by at least one radio of a wireless device;
for at least one transmit frequency band of the one or more transmit frequency bands, determining a respective transmit power limit for at least one subband in the at least one transmit frequency band for one or more transmit scenarios supported by the wireless device, such that a respective radio frequency (RF) exposure level for the at least one radio used in a transmission is in compliance with an RF exposure limit; and
storing indications of the transmit power limits in a memory device.

11. The method of claim 10, wherein determining the respective transmit power limit for the at least one subband comprises:
determining a plurality of representative transmit power limits for a respective plurality of frequencies within a particular subband; and
setting the respective transmit power limit for the particular subband to a minimum of the plurality of representative transmit power limits.

12. The method of claim 11, wherein the indications of the transmit power limits comprise indications of the plurality of representative transmit power limits for each particular subband.

13. The method of claim 11, wherein the plurality of frequencies comprises at least one of a lowest frequency of the particular subband, a middle frequency of the particular subband, or a highest frequency of the particular subband.

14. The method of claim 10, wherein determining the respective transmit power limit for the at least one subband comprises determining an amount of RF exposure associated with the at least one radio for the at least one subband.

15. The method of claim 10, wherein the at least one subband comprises multiple subbands and wherein a number of the multiple subbands in the at least one transmit frequency band is based on an amount of RF exposure variation in the at least one transmit frequency band.

16. The method of claim 10, wherein the at least one subband comprises a first subband and a second subband and wherein the first subband is contiguous with respect to the second subband.

17. The method of claim 10, wherein the at least one subband comprises a first subband and a second subband and wherein the first subband is non-overlapping with respect to the second subband.

18. The method of claim 10, further comprising:
determining a first configuration of the at least one subband to be applied when the wireless device operates according to a first transmit scenario of the one or more transmit scenarios; and
determining a second configuration of the at least one subband to be applied when the wireless device operates according to a second transmit scenario of the one or more transmit scenarios.

19. The method of claim 10, wherein the RF exposure limit is a time-averaged RF exposure limit.

20. The method of claim 10, wherein an amount of RF exposure variation in the at least one transmit frequency band is greater than a threshold.
